(19) United States
(12) Patent Application Publication
(10) Pub. No.: US 2007/0288336 A1
(43) Pub. Date: Dec. 13, 2007

(54) Method and System For Advanced Financial Analysis

(75) Inventors: Paritosh Malaviya, Cupertino, CA (US); Tejaswi Sundarram, Bangalore (IN)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: finEye Corporation

(21) Appl. No.: 11/745,086

(22) Filed: May 7, 2007

Related U.S. Application Data
(60) Provisional application No. 60/746,627, filed on May 5, 2006.

(51) Int. Cl. G06Q 40/00

(52) U.S. Cl. 705/35

(57) ABSTRACT

A method and system for advanced financial analysis are disclosed In one embodiment, a computer-implemented method comprises collecting financial data from a plurality of data sources. Information is extracted from the financial data using a company specific template. The information is analyzed to generate results using customizable rules stored in a rules database. The results are provided to a user through a display device.

The present application claims the benefit of and priority to U.S. Provisional Patent Application No. 60/746,627 entitled “Method and System for Providing Financial and Operational Analysis” and filed on May 5, 2006, and is hereby, incorporated by reference.

### FIELD OF THE INVENTION

The field of the invention relates generally to computer systems and more particularly relates to a method and system for advanced financial analysis.

### BACKGROUND OF THE INVENTION

Financial analysis involves the use of various financial formulas and interpretations to measure the financial strengths and weaknesses of a company and to compare these strengths and weaknesses with those of other companies within an industry. Financial analysis information may be valuable to those within a company (e.g., officers, and financial managers) and to those outside of a company (e.g., investors, creditors, and security analysts).

Financial interpretations involve the use of various factors that could reflect a financial situation. For example, assumptions made to compute pension costs and obligations are generally manipulated by companies to smoothen earnings. So, a simple change in the assumption can impact earnings to a large extent. Such interpretations are made using specified financial models. These interpretations would require the use of fuzzy logic on financial statement data or on a derived calculation. The derived calculations also called as a “Complex data item” could be a ratio or a statistical calculation on a basic financial statement data. Various financial models created handle aspects like Earnings Overstatement/Understatement, Comparison of Cash flows against Income, Determination of Total financial leverage, Impact of Pensions on Earnings, Impact of stock options on earnings and dilutions, Impact of “Off Balance Sheet Items” on the balance sheet, Liquidity Risk, Identification of a company being a Value Creator or destroyer etc.

Financial ratios are designed to show relationships between various financial statement accounts. For example, Company A may have debt of $4,000,000 and interest charges of $700,000, while Company B may have debt of $64,000,000 and interest charges of $7.700.000. The actual burden of these debts, and the companies' ability to repay them, can be determined by comparing each company's debt to its assets, and the interest each company is charged to the income available for payment of interest. Such comparisons are made by a procedure known as “ratio analysis.”

Various known categories of ratios include liquidity ratios, asset management ratios, debt management ratios, profitability ratios, and market value ratios. Liquidity ratios are designed to show the relationship of cash and other current assets to a company's current obligations. Asset management ratios are designed to measure how effectively a company is utilizing its assets. Debt management ratios are designed to measure the extent to which a company uses debt financing. Profitability ratios are designed to show the combined effects of liquidity, asset management, and debt management on operating results. Market value ratios are designed to relate the stock price of a company to the company's earnings and book value per share.

Financial analysis may allow a financial manager to compare his or her company's financial performance with the financial performance of other companies in the same industry. In addition, analyzing trends may allow a financial manager to analyze changes in a company's financial performance over time.

Performing financial analysis and interpreting results from financial analysis may be a somewhat daunting task, especially to those untrained in managerial finance. For example, to some it may not be clear how to utilize ratio analysis in assessing the financial health of a company. Moreover, it may be difficult for some to compare the financial performance of their company to the financial performance of other companies.

Financial analysis services are available from various professional advisors, such as consultants and accountants. Unfortunately, these services may be expensive and limited to a specific set of companies. In addition, existing financial analysis products and services may be somewhat limited in the depth of analysis that can be produced. Moreover, existing financial analysis products and services may not be able to indicate how a company is performing relative to the competition and how the company might improve performance.

Various financial software products and services exist that can analyze one or more of the four basic financial statements (i.e., the income statement, balance sheet, statement of retained earnings, and statement of changes in financial position). For example, Entrepreneurial Edge Online (www.edgeonline.com) is a service of the Edward Lowe Foundation (P.O. Box 8, Cassopolis, Mich. 49031) that provides on-line forms in which users can enter data. Using the user-provided financial data, various ratios and financial statements can be generated. For example, a balance sheet can be generated and ratios such as liquidity, operating and solvency ratios can also be generated.

CPAnalyst financial software, available from the Illinois CPA Society (www.icpas.org) is configured to receive financial data from users and convert this data into various types of output, including financial statements, ratios, graphs and limited narrative reports. The narrative reports, however, consist of templates having fields within which financial data, including financial ratio values are inserted. The written description in each narrative report is identical for each output report.

### SUMMARY

A method and system for advanced financial analysis are disclosed. In one embodiment, a computer-implemented method comprises collecting financial data from a plurality of data sources. Information is extracted from the financial data using a company specific template. The information is analyzed to generate results using customizable rules stored in a rules database. The results are provided to a user through a display device.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles of the present invention.

FIG. 1 illustrates an exemplary investment decision support process, according to one embodiment.

FIG. 2 illustrates an exemplary data collection and harvesting system, according to one embodiment.

FIG. 3 illustrates an exemplary data extraction and standardizing system, according to one embodiment.

FIG. 4 illustrates an exemplary automated data extraction system, according to one embodiment.

FIG. 5 illustrates an exemplary mapping process, according to one embodiment.

FIG. 6 illustrates an exemplary rule based interpretive analysis system, according to one embodiment.

FIG. 7 illustrates an exemplary financial analysis process, according to one embodiment.

FIG. 8 illustrates an exemplary fuzzy rule execution process, according to one embodiment.

### DETAILED DESCRIPTION

A method and system for advanced financial analysis are disclosed. In one embodiment, a computer-implemented method comprises collecting financial data from a plurality of data sources. Information is extracted from the financial data using a company specific template. The information is analyzed to generate results using customizable rules stored in a rules database. The results are provided to a user through a display device.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. A method is here, and generally, conceived to be a self-consistent process leading to a desired result. The process involves physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such Information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (“ROMs”), random access memories (“RAMs”), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

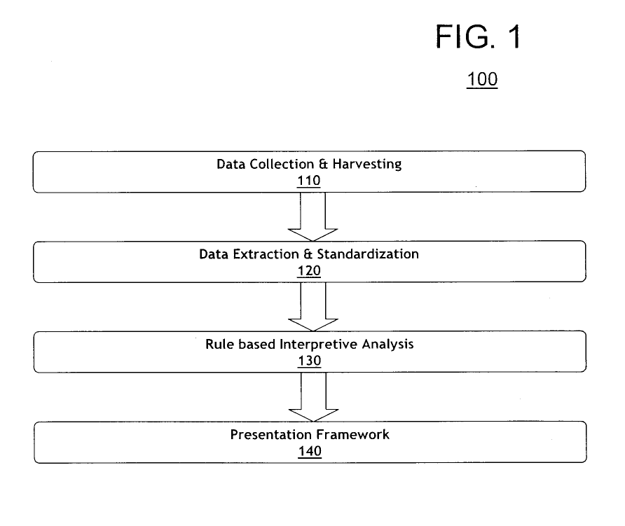

FIG. 1 illustrates an exemplary investment decision support process 100, according to one embodiment. Process 100 for an investment decision support system operates on a company's financial and operational performance data by:
Collecting and harvesting investment information embedded in semi-structured documents (110)
Organizing, extracting and standardizing data dynamically into a well defined database without permanently modifying the reported data (120)
Performing rule based interpretive analysis to build a database of historical performance and predictions (130)
Offering the user to screen and browse the analysis database or make interactive changes to the analysis (140)

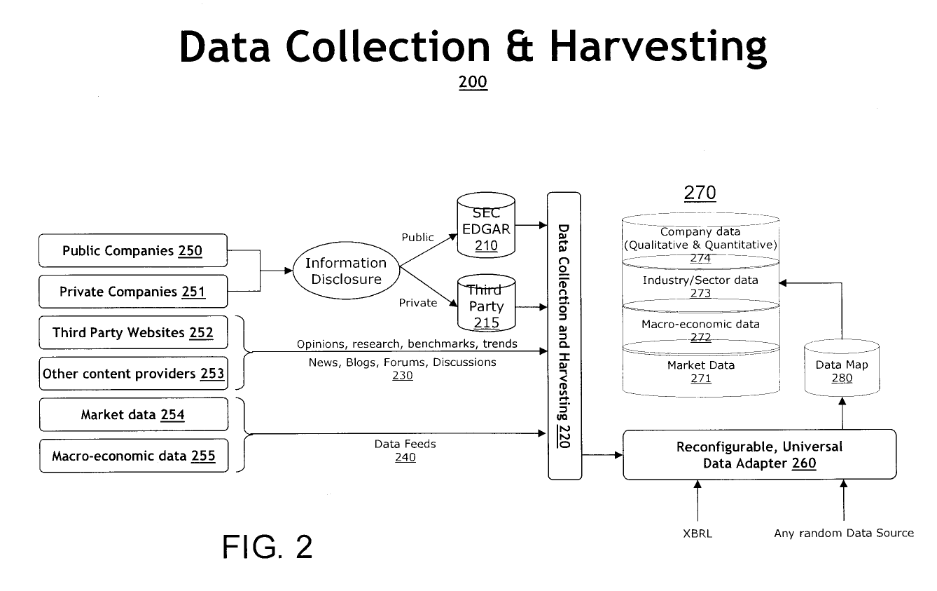

FIG. 2 illustrates an exemplary data collection and harvesting system 200, according to one embodiment. Data collection and harvesting system 200 may be used to perform a data collection and harvesting process 110. A good investment decision requires information on a company in its entirety. Data collection and harvesting module 220 gathers information from the U.S. Securities and Exchange Commission's (SEC) EDGAR database 210, news and company websites 230, Internet blogs 230, data feeds 240, and independent research.

One source of information used by system 200 is the SEC EDGAR database 210, where public companies 250 disclose their financial as well as non financial information in the form of regulatory filings (in HTML, XBRL, Text, and PDF formats) stored in the SEC EDGAR database 210. For private company 251 analysis, the source of data would be third party databases 215. A universal reconfigurable data adaptor 260 is used to store the semi structured data provided by module 220 into the database 270 with the help of the data map 280. A secondary source is third-party websites 252 and third party database 215, content or database providers and online data feeds from where private company filings are collected, news, research reports/opinions, reports on market trends and benchmarks, financial discussions, forums and blogs 230.

Also used by system 200 for financial analysis is market data 271 of public companies (market capitalization on any particular day, stock prices, market situation, etc) and macro economic data 272 (Treasury-bill rates, currency exchange rates, LIBOR rates, etc). Based on predetermined parameters a harvesting application 220 periodically scans the SEC EDGAR database 210 and other sources 250-255 for the required information of companies and gathers the same.

Information gathered from these varied sources (in varied forms) is harvested on a regular basis in database 270 and organized into the following categories using a data map 280.
Qualitative and Quantitative Company Data 274
Industry Data 273
Market Data 271
Macro-Economic Data 272

A universal reconfigurable data adaptor 260 aids in the storage of the entire above mentioned semi structured data provided by the data collection and harvesting module 220, external XBRL feeds and any other random data sources, irrespective of the format they are specified in. Data adaptor 260 along with the information in datamap 280 stores the data into the database 270 with the logical partitions 271-274.

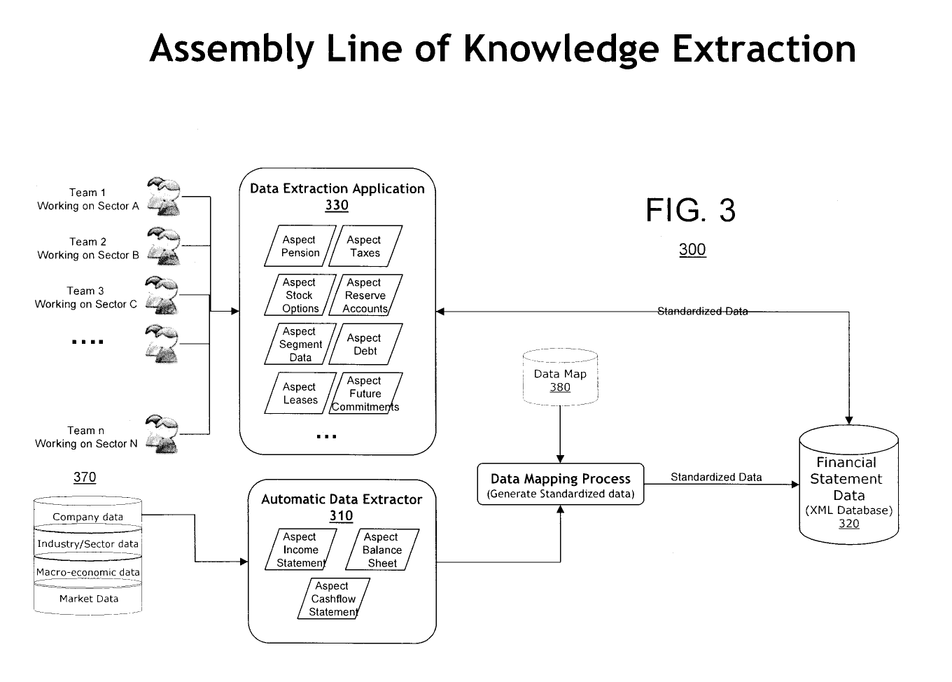

FIG. 3 illustrates an exemplary data extraction and standardizing system 300, according to one embodiment. Data extraction and standardizing system 300 performs a data extraction and standardization process 120 that is similar to an assembly line of knowledge extraction. System 300 includes an automatic data extractor 310, an XML database 320, database 370, datamap 380, and a data extraction application 330 which is used to feed data into the XMI database 320. The data extraction application 330 is used to feed data extracted manually by teams which are divided based on a sector. These teams work on all companies in the given sector. Each member in a team is assigned to work on an aspect which is a logical partition of the financial data based on its utility in financial analysis. The different aspects that extracted are Income Statement, Balance Sheet, Cash flow statement, Pensions, Income Taxes, Stock Options, Reserve Accounts, Debt, Segmental Info, and Off-Balance sheet items.

Companies reporting financial information are guided by the standards set by the Financial Accounting Standard Board (FASB). The manner in which such financial information is reported is unique to each company. eXtensible Business Reporting Language (XBRL) is one of a family of “XML” languages which is becoming a standard means of communicating information between businesses and on the internet. XBRL is the first step in normalizing financial information reporting. System 300 provides a process and application for data mining financial information to tackle inconsistencies in financial reporting. Different components of the data extraction process are:
A process to automate the workflow
Automated and manual data extraction
Defect tracking and quality assurance process
Performance Metrics

Data items that have been harvested by system 200 are processed to retrieve relevant and standardized information for analysis using a manual as well as an automated process.

Automated Data Extraction: Some parts of financial reports such as the Income Statement, Balance Sheet and Cash flow statements have a consistent format of reporting for a company across all its filings. System 300 includes an automated system for creating a company specific template by replicating the structure of one filing of the company and using the same template to search and retrieve the data from other filings of that company. Templates are updated whenever new line item/items are identified. This company template is then normalized by mapping it to industry and/or sector specific financial statement template.

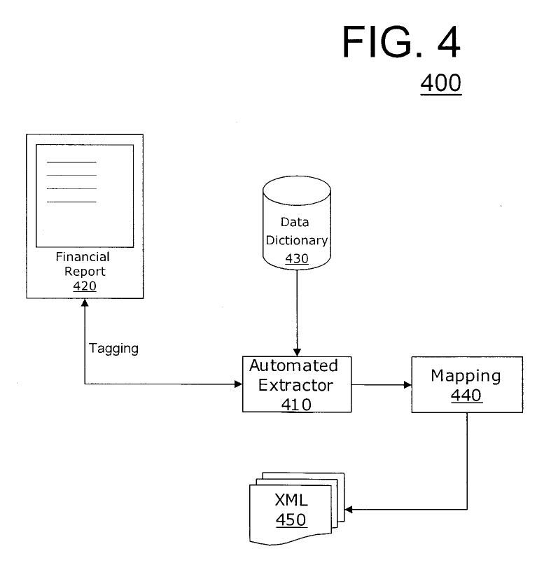

FIG. 4 illustrates an exemplary automated data extraction system 400, according to one embodiment. An automated extractor 410 performs the following operations:

Extraction of data items based on company specific templates—A specific template is defined for each of the aspects 340, 350 (IS, BS, CF etc) to be extracted. These templates contain the line items as in the reported financial report. Whenever a new report is received, it is parsed on the basis of this template. A string matching algorithm is used to tie the data item in the financial report to the data item in the respective template.

Extraction of data items using the data dictionary (DD)—A financial report 420 in HTML format is parsed using an HTML parser where all tables are extracted. The data items mentioned under the <table> tags are compared with the items in the data dictionary 430 and a match is found. The system uses the name from the dictionary 430 instead of the name mentioned in the annual report 420. This is helpful during the mapping process 440 since the data item names would be consistent. These field names in the data dictionary 430 are picked up across the financial report 420. The component includes a self-learning feature where new words are added to the dictionary 430. For example, a company can report Revenues in different ways like “Global Revenues”, “Sales to Customers” etc. All these items are the same. The data dictionary 430 has a list of synonyms for a particular data item. The generic data item name from the data dictionary 430 is used in the mapping process instead of the as reported data item name.

Tagging of data items and values that have been extracted—The data items that have been extracted automatically or manually are tagged to enable any of the presentation framework components to drill-down to the exact location of the data item in the financial report 420.

The entire financial report 420 is divided into sections such as income statement, balance sheet, cash flow statement, pensions, income taxes etc. This process is done automatically, as well as manually with the help of tags.

The data dictionary 430 is a database of all keywords (hereafter called as ‘As Reported data items’) found while parsing the financial report 420. The data dictionary 430 contains industry specific line items as well as generic data items. The dictionary 430 also includes the normalized data items are mapped to the as reported data items in the mapping process 440.

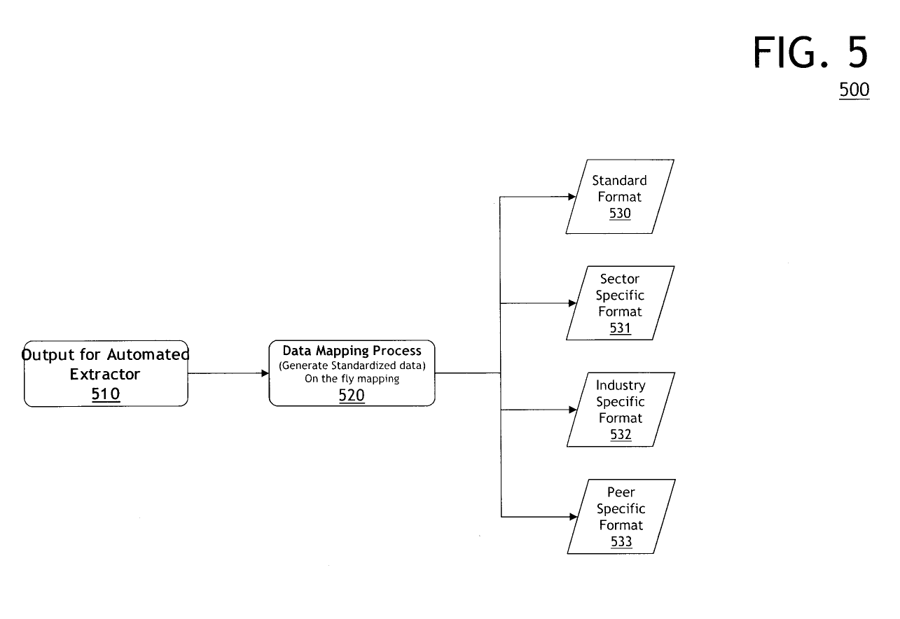

FIG. 5 illustrates an exemplary mapping process 500, according to one embodiment. The mapping process 500 converts the data items 510 extracted from an SEC filing to a normalized standard structure 530 using the data map 520. The data items in the normalized standard structure 530 are used in defining the analysis. The data map 520 provides a relation between the as reported data items 510 and the normalized item 530. The normalized items 530 depend upon the structure used during the normalization process. The different structures include a standard/generic format 530, a sector specific format 531, an industry specific format 532 or a peer specific format 533.

An example of a mapping process 500 may involve a company that can disclose the data item “Cost of Goods Sold” under different components like “Fuel and Purchased Power”, “Salaries”, “Fuel Expenses”, “Cost of sales” etc. These components need to be mapped into the normalized data item 530 “Cost of Goods Sold”. This can be achieved by creating a map between the as reported data items 510 and the normalized data items 530.

The output of the mapping process 500 is a normalized/standardized formatted data item 530 in XML and is saved into the database 270 for further processing (QA).

Manual Extraction: The retrieval of portions of a financial report that cannot be extracted using the automated process 500 is achieved by a manual extraction process with the help of a tool which provides a user interface for capturing data for each aspect. An aspect is a logical partition of the financial data based on its utility in financial analysis.

A feature where the semi structured data is split into smaller parts enables a data analysts to narrow down the report and extract the relevant information during the manual extraction process is provided.

Extensive research of FASB standards/pronouncement, SEC's disclosure requirements and actual financial reports like Form 10-K (annual reports), Form 10-Q (quarterly reports), Form 8-K, earnings releases, Sector/Industry specific reporting have helped us create normalized formats/templates for each aspect whose data needs to be extracted for analysis.

The extracted data is stored in the input data store in a unique XML structure. This database is used at a later stage in the analysis process of the system.

The quality of data extracted-manually and automatically may also be checked by a team of quality analysts. They are assisted in this process by automated checks set up in the QA extraction application module. Errors identified are notified to the data analyst. Data errors fixed are QA passed by the QA analyst and a company is ready for analysis.

A data operations team is comprised of data analysts and quality assurance analysts. Each team of data analysts handles the extraction of data for all companies in a given sector. Automated work queues are generated based on harvested data for a company. This system also allows the changing of priority for each work packet manually. The system allocates the work packet for QA after the data extraction process is completed. Data on the extraction and QA status is collected for use in reporting and performance metrics.

System 300 provides a reporting tool which is used for displaying the status of any company in the context of the workflow at any given period. The ability to assess the performance of a team member is also provided.

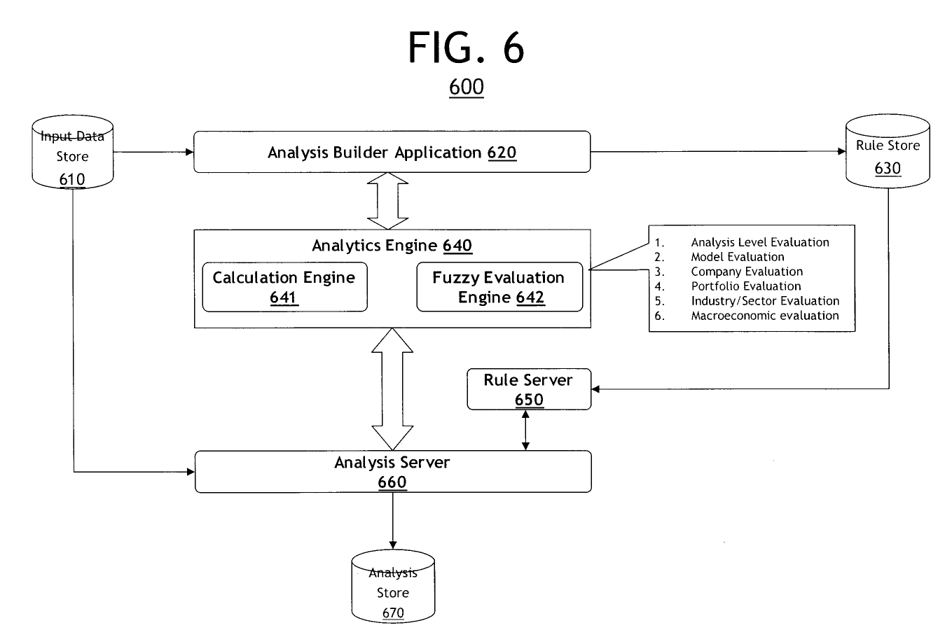

FIG. 6 illustrates an exemplary rule based interpretive analysis system 600, according to one embodiment. The different inputs required for evaluation of an analysis is stored in an input database 610 and consists of the following types of data:
Qualitative and quantitative company data
Industry data
Market data
Macro economic data

An analysis builder module 620 is a workbench application for the development and testing of rules required for analysis. The analysis builder module 620 supports the visual building of qualitative or quantitative analysis by operating on data stored in the input data store 610. The logic of analysis is expressed in a programming language. The language has generic constructs and operators provided by modern computer languages. In addition, it provides the ability to add and describe any random linguistic term to express heuristic thoughts/human logic that is not easily described in mathematical terms. For illustration purpose, a simplified example of this could be the situation where a financial analyst might think that a given company is performing “poorly” if a particular financial ratio is “growing rapidly”. In the language these linguistic terms can be described and the data can be analyzed.

An analysis can be generic or specific to a company/Industry/Sector. The analysis builder module 620 supports the creation of analysis using a financial analysis rule language (FARL). The sector and industry analysis are created with the help of templates. The order of evaluation of an analysis is based on the hierarchy given below:
Company specific analysis
Industry specific analysis
Sector specific analysis
Generic analysis

Support for testing of analysis is provided to validate the analysis before it is finally stored in the rule store 630. A version control feature exists, as well as support for creating multiple levels of sub rules.

Each analysis is specified to be evaluated on a particular analysis model and analysis periods (Quarterly, Annual, Quarterly Year on Year basis & Trailing twelve months).

An analysis can be marked for benchmark calculation. A benchmark analysis is an analysis which can be used for peer comparison.

The structure of an analysis is given below:
Metadata (Id, Priority, Enabled, Version etc)
Description
Hierarchy (Generic, Model, Company, Industry, Sector)
Categories
Logic representation (Equation)
Logic for data display
Thresholds along with the text to be displayed
Data Source Information(Annual, Quarterly, TTM, ER, other filings types like 424B, restatements)

A rule based interpretive analysis system 600 includes a rule store 630. Analysis developed using the analysis builder module 620 is stored in rule store 630 and the rules are version controlled. The different types of analysis stored are Calculations and Fuzzy analysis. System 600 also includes a rule server 650. Rule server 650 is used for retrieval of analysis based on a certain input criteria as requested by other subsystems that require analysis for evaluation. Rule server 650 is an online system which polls the rule store 630 for any change in the analysis and updates the cache with the latest version. The system 600 provides for retrieval of Sector/Industry/Company specific analysis, analysis of specific version, benchmark analysis. It also supports the retrieval of recently changed analysis.

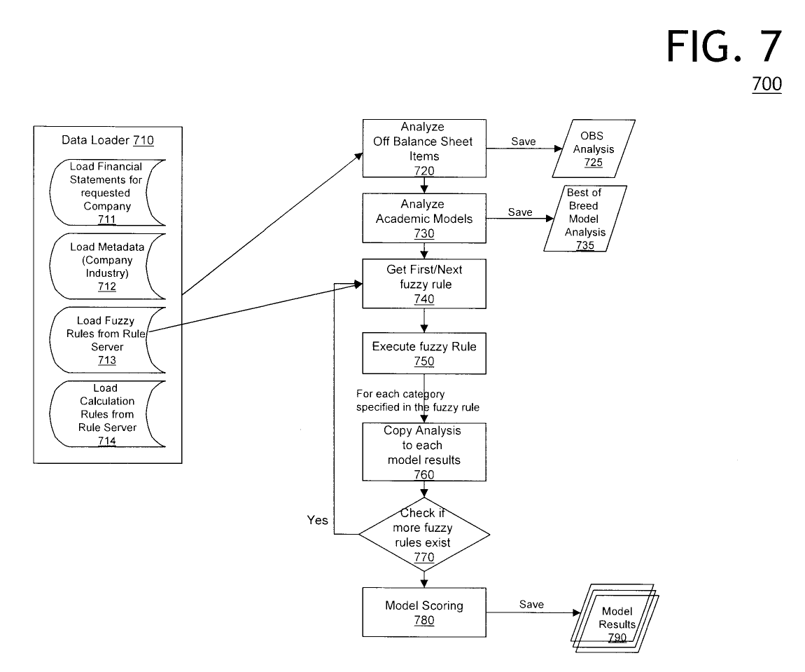

FIG. 7 illustrates an exemplary financial analysis process 700, according to one embodiment. Process 700 utilizes a data loader 710 to provide various types of information for processing, including:
financial statements 711
metadata 712
fuzzy rules from the rule server 713
calculation rules from the rule server 714

Off balance sheet items are analyzed (720), adjustments are made to the primary statements and saved (725). Academic models are analyzed (730) and saved for a best of breed model analysis (735). A first or next fuzzy rule is loaded from the rule server (740) and the rule is executed using the fuzzy engine (750). For each category specified in the fuzzy rule, an analysis is copied to each model result (760). If more fuzzy rules exist, the process loads and executes the rule as well as copying the analysis to the model results. The resulting model is scored (780) and the results are provided by the system (790).

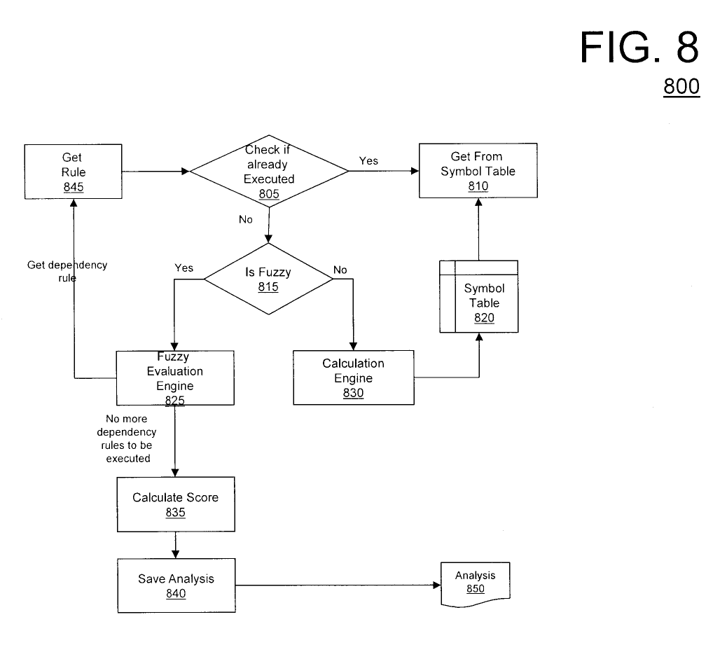

FIG. 8 illustrates an exemplary fuzzy rule execution process 800, according to one embodiment. Process 800 may be used in process 700 for executing fuzzy rules (750). System 660 checks to see if the fuzzy rule has already been executed. (805) If already executed, the result value is retrieved (810) from a symbol table 820. If not already executed, system 660 determines if the rule is fuzzy (815). If the rule is fuzzy, the fuzzy evaluation engine 642 executes (825). Otherwise, the calculation engine 641 (830) executes, and the symbol table 820 is updated. Based on the results of the fuzzy evaluation engine 642 (825), rules are retrieved (845). Also based on the results of the fuzzy evaluation engine 642, a score is calculated (835), the analysis is saved (840) into an analysis record 850. In addition to the above processing, calculation rules which have been marked as a ratio are processed and stored in a ratio results XML document.

Returning to FIG. 6, analytics engine 640 supports the evaluation of analytical results that are created using a financial analysis rule language (FARL). The language supports control flow statements like if-then-else, for and continue, built in functions for statistical calculations, data retrieval methods, data forwarding methods, etc. FARL also provides a library of functions used for complex calculations such as stock volatility, etc. Analytics engine 640 provides a hierarchical evaluation of the analytical results, including:
1. Analysis level evaluation
2. Model level evaluation
3. Company level evaluation
4. Peer level evaluation
5. Portfolio level evaluation
6. Industry level evaluation
7. Sector level evaluation
8. Macro economic level evaluation

The analytics engine 640 supports the calculation of analytical scores (such as scores 835) at the analysis level, model level, and company level evaluations. These scores may be used for grading purposes. The analytics engine 640 evaluates custom models with two sub systems namely calculation engine 641 and fuzzy evaluation engine 642.

The calculation engine 641 supports the concrete evaluation of arithmetic operations on financial data. It provides for the evaluation of statistical functions ranging from simple calculations such as a standard deviation to complex calculations like forecasting. Support for peer group comparison also exists.

The basic building blocks for a calculation are simple data items (financial data) and/or another calculated data item itself. The result of the evaluation is a complex data item which would form the input for the analysis evaluated by the fuzzy engine. Complex data items include single values or an array of values, where each value is related to a certain period. Complex data items are created using Analysis Builder and has the following attributes:
1. Analysis ID
2. Keyword or Categories—Used to specify the models/categories to which this analysis belongs to. During the execution of the analysis, the results are copied to the models to which it belongs to.
3. Analysis Type—Should be always set to COMPLEX_DATA for all calculations.
4. Description
5. Equation—Specify the equation for the calculation using FARL.
6. Display Data Equation—Equation for the data that needs to be displayed in the presentation framework. This would basically be a table and graph. The important functions used in this equation are SetGraphType( ) and display( ). All functions that are used for creating a complex data item can be used here.
7. Related Data Items—Specify all related data items
8. Related Analysis—Specify all related analysis
9. Analysis Periods—Specify the periods (Annual, Quarterly,TTM) on which the analysis needs to be executed.
10. Dependency—This attribute is automatically filled in when a simple data item or complex data item is referenced in the equation or display data equation.

According to one embodiment, the calculation engine 641 uses the following syntax of the financial analysis rule language (FARL):

| | |
|---|---|
| rule: | (statement)* |
| statement | :ifStatement |
| | \| declareStatement |
| | \| forStatement |
| | \| assignment |
| | \| breakStatement |
| | \| continueStmt |
| | \| returnStatement |
| | \| displayStatement |
| | \| setGraphTypeStatement |
| | \| LBRACE! (statement)* RBRACE! |
| declareStatement | :“declare” IDENTIFIER |
| ifStatement | :“if” expression “then” statement “else” statement |
| forStatement | :“for” LPAREN for_range RPAREN statement |
| for_range | :IDENTIFIER ASSIGNMENT range |
| range | :number_variable COLON number_variable |
| returnStatement | :“return” (expression)? |
| displayStatement | :“display” LPAREN expression COMMA STRING_LITERAL |
| | COMMA STRING_LITERAL (COMMA binaryElement)? |
| | RPAREN |
| setGraphTypeStatement: | “SetGraphType” LPAREN graph_type RPAREN |
| functions | :“Absolute” LPAREN lValue RPAREN |
| | \| “Slope” LPAREN data_item COMMA num_periods COMMA |
| | num_periods COMMA period COMMA binaryElement RPAREN |
| | \| “SlopeInDegrees” LPAREN data_item COMMA num_periods COMMA |
| | num_periods COMMA period COMMA binaryElement RPAREN |
| | \| “Mean” LPAREN data_item COMMA num_periods COMMA period |
| | RPAREN |
| | \| “StandardDeviation” LPAREN data_item COMMA num_periods |
| | COMMA period RPAREN |
| | \| “IsValidNumber” LPAREN lValue RPAREN |
| | \| “IsInfinite” LPAREN lValue RPAREN |
| | \| “EXP” LPAREN number_variable RPAREN |
| | \| “Power” LPAREN lValue COMMA lValue RPAREN |
| | \| “Median” LPAREN data_item COMMA num_periods RPAREN |
| | \| “Variance” LPAREN data_item COMMA num_periods RPAREN |
| | \| “GetPeriodEnding” LPAREN num_periods RPAREN |
| | \| “CompareDate” LPAREN dateString COMMA dateString RPAREN |
| financial_functions | :“CAGR” LPAREN data_item COMMA number_variable |
| | COMMA num_periods RPAREN /*CAGR(dataitem,beginning |
| | period, number of years)*/ |
| | \| “BlackScholesValuation” LPAREN optionsType (COMMA |
| | num_periods)? RPAREN |
| | \| “Benchmark” LPAREN data_item COMMA num_periods |
| | COMMA STRING_LITERAL RPAREN |
| | \| “MarketData” LPAREN STRING_LITERAL COMMA |
| | num_periods RPAREN |
| | \| “StockVolatility” LPAREN number_variable RPAREN |
| data_item | :IDENTIFIER |
| graph_type | :“BAR” \| “PIE”\| “LINE” \| “AREA” |
| period | :“annual” \| “quarterly” \| “ttm” \| “qq” ; |
| threshold_type | :“percentage” \| “absolute”; |
| result_type | :“calculated” \| “absolute”; |
| sign_type | :“positive” \| “negative”; |
| higher_lower | :“higher” \| “lower”; |
| number_variable | :NUMBER |
| | \| IDENTIFIER |
| num_periods | :number:NUMBER |
| | \| localIdent:IDENTIEIER |
| decliningflag | :“declining” \| “growing”; |
| breakStatement | :“break” |
| continueStmt | :“continue” |
| assignment | :lValue ASSIGNMENT expression |
| expression | :relational ((“and”\|“or”) relational)* ; |
| relational | :addition ((“==”\|”<>”\|”>”\|”>=”\|”<”\|”<=”) addition)* |
| addition | :multiplication ((PLUS\|MINUS) multiplication)* ; |
| multiplication | :signExpression ((MULTI\|DIV\|MOD) signExpression)* |
| signExpression | :PLUS primitiveElement |
| | \| MINUS primitiveElement |
| | \| primitiveElement |
| lValue | :IDENTIFIER\hat{ } (LBRACK! index RBRACK!)*; |
| index | :addition; |
| primitiveElement | :IDENTIFIER\hat{ } (LBRACK! index RBRACK!)* |
| | \| NUMBER |
| | \| STRING_LITERAL |
| | \| LPAREN! expression RPAREN! |
| | \| binaryElement |
| | \| functions |
| | \| financial_functions |
| | \| “NAN”\hat{ } |
| | \| “DAYS”\hat{ } |
| binaryElement | :“TRUE” \| “FALSE” |
| optionsType | :“granted” \| “outstanding” \| “granted-disclosed”; |
| dateString | :STRING_LITERAL |
| | \| lValue |

The fuzzy evaluation engine 642 supports evaluation of fuzzy analysis using the linguistic values of the inputs specified and the fuzzy rule base of the analysis. The fuzzy evaluation engine 642 supports rule blocks, and/or/not operations with nesting of fuzzy expressions on the input side of the rule.

The input for a fuzzy rule can either be the result of a calculation (complex data item) or a simple data item or a fuzzy rule itself. In addition to these, a growth trend or volatility of a simple data item or a complex data item may be expressed as the input linguistic variable (eg., using the functions GrowthTrend( . . . ) and Volatility( . . . )).

Each fuzzy analysis template allows the rule author to specify the input linguistic variable as well as the output linguistic variable. A linguistic variable is a variable which has linguistic values like high, low, declining, increasing etc with associated degrees of membership in the set. These linguistic variables take on values defined in its term set which are a set of linguistic values. For example, the linguistic variable CF_AdjustedCFFOlessDepreciation_NI, the term set T(CF_AdjustedCFFOlessDepreciation_NI) is defined as:

T(CF_AdjustedCFFOlessDepreciation_NI)={“low”, “high”, “Negative”, “Average”}

According to one embodiment, each of the linguistic variables has specified membership functions. Linguistic values or terms have defined membership functions. Examples of the type of membership functions used are Trapezoidal, Gaussian and Bell. The concrete/crisp input values are fuzzified into their linguistic values before the evaluation of the fuzzy rule. The membership functions can have a range of −∞ to +∞.

The fuzzified value of input value X for the membership function of type Trapezoidal is:

f(X;a,b,c,d)=Max(Min((X−a)/(b−a),1,(d−X)/(d−c)),0)

If the value of X is less than b and a is −∞, f(X;a,b,c,d)=1. The same is true if value of X>c and d is ∞. The fuzzified value of input value X for the membership function of type Bell is:

f(X;a,b,c)=1/(1+|(x−c)/b|^{2b})

The fuzzified value of input value X for the membership function of type Gaussian is

f(X;a,b,c)=e^{-(1/2)*Square(((x-c)/sigma))}

Fuzzy rules may be represented by text strings in the following format:

IF InputLinguisticVariable-1 IS <hedge> MembershipFn-1 <AND/OR
InputLinguisticVariable-1 IS <hedge> MembershipFn-2>... THEN
OutputLinguisticVariable IS <hedge> MembershipFn

The fuzzy evaluation engine 642 supports the use of hedges like “not”, “very”, “somewhat”, “close to” or “extremely”. The output of fuzzy evaluation engine 642 is a linguistic value for the output linguistic variable for which a defuzzification method is applied. The methods used for defuzzification are Center-of-Area (CoA, also called the Center-of-Gravity), Center-of-Maximum (CoM), Mean-of-Maximum (MoM), Left-of-Maximum (LOM) or Smallest-of-Maximum (SoM), Right-of-Maximum (ROM) or Largest-of-Maximum (LoM), and Bisector-of-Area (BoA).

The result of a fuzzy evaluation provides an analytical result, such as a REDFLAG, WARNING or INSIGHT based on the defuzzified value of the output linguistic variable and the corresponding threshold specified in the analysis. A fuzzy analysis/rule is created using Analysis Builder and has the following attributes:
1. Analysis ID
2. Keyword or Categories—Used to specify the models/categories to which this analysis belongs to. During the execution of the analysis, the results are copied to the models to which it belongs to.
3. Analysis Type—Should be always set to INSIGHT for all fuzzy analysis
4. Description
5. Equation—Specify the fuzzy equation that needs to be evaluated. Grammar for the calculation analysis (Complex data Items) cannot be used here.
6. Display Data Equation—Equation for the data that needs to be displayed in the presentation framework. This would basically be a table and graph. The important functions used in this equation are SetGraphType( ) and display( ). All functions that are used for creating a complex data item can be used here.
7. Linguistic Variables—Specify all the input & output linguistic variables along with their membership function.
8. Display Text—Specify the text to be displayed for the analysis in the presentation framework based on the defuzzified values.
9. Related Data Items—Specify all related data items
10. Related Analysis—Specify all related analysis
11. Analysis Periods—Specify the periods (Annual, Quarterly,TTM) on which the analysis needs to be executed.
12. Dependency—This attribute is automatically filled in when a simple data item or complex data item is referenced in the equation or display data equation.
13. Benchmark—Specifies whether the rule needs to be benchmarked.

A sample XML structure of a fuzzy rule is:

```
<rules>
  <rule benchmark=“false”
      categories=“Adj Cashflows vs. Income,Earnings Overstated,Earnings
      Understated”
      description=“Calculate CFFO to NetIncome Level”
      display_data=“a:=CF_CFFO_Adjusted_Final;
            b:=CashflowStatement.Operations.depreciationAndAmortization;
            c:=CF_Adjusted_NI;
            for(i:=0:NUMPERIODS){
            d:=(a[i]−b[i])/c[i];e:=a[i]−b[i];
            display(e[i],”CFOlessdepre”,”Adj CFFO less Depr and Amortization”);
            display(c[i],”NI”,”Adjusted Net Income”);
            display(d[i],”ratio”,”Adj CFFO minus D&A/Adjusted Net Income”);
            }”
      equation=“if CF_AdjustedCFFO_minus_depreciation is Positive and
      CF_AdjustedCFFOlessDepreciation_NI is high and CF_Adjusted_NI is
      Positive then balancesheet_quality is High;
        if CF_AdjustedCFFO_minus_depreciation is Positive and
        CF_AdjustedCFFOlessDepreciation_NI is low and CF_Adjusted_NI is
        Positive then balancesheet_quality is Medium;
        if CF_AdjustedCFFO_minus_depreciation is Positive and
        CF_AdjustedCFFOlessDepreciation_NI is Average and CF_Adjusted_NI
        is Positive then balancesheet_quality is Average;
        if CF_AdjustedCFFO_minus_depreciation is Negative and
        CF_AdjustedCFFOlessDepreciation_NI is high and CF_Adjusted_NI is
        Negative then balancesheet_quality is Low;
        if CF_AdjustedCFFO_minus_depreciation is Negative and
        CF_AdjustedCFFOlessDepreciation_NI is low and CF_Adjusted_NI is
        Negative then balancesheet_quality is High;
        if CF_AdjustedCFFO_minus_depreciation is Negative and
        CF_AdjustedCFFOlessDepreciation_NI is verylow and CF_Adjusted_NI
        is Negative then balancesheet_quality is High;
        if CF_AdjustedCFFO_minus_depreciation is Negative and
        CF_AdjustedCFFOlessDepreciation_NI is Average and CF_Adjusted_NI
        is Negative then balancesheet_quality is Average;
        if CF_AdjustedCFFO_minus_depreciation is Positive and CF_Adjusted_NI
        is Negative then balancesheet_quality is High;
        if CF_AdjustedCFFO_minus_depreciation is Negative and
        CF_Adjusted_NI is Positive then balancesheet_quality is Low”
      fuzzy=“true”
      id=“CF_AdjustedCFFOlessDepre_Netincome_level”
      type=“INSIGHT”>
  <relations>
    <data_items/>
    <rules>
        <rule id=“Ratio_AggCFFO_AggNetincome_Level”/>
  <rule id=“Ratio_AggCFO_minusdepre_AggNetIncome_Level”/>
        <rule id=“Ratio_CFFO_Volatility”/>
        <rule id=“Ratio_CFFO_NetIncome_Level”/>
        <rule id=“Ratio_CFFO_NetIncome_Volatility”/>
            <rule id=“Ratio_CFOlessdepre_NetIncome_Volatility”/>
      </rules>
  </relations>
  <display_text from=“0.8501” to=“1” type=“REDFLAG” value=“%name%'s adjusted net
  income is much more substantial than its adjusted CFFO less D&A. This is generally a
  sign of poor earnings quality.” direction=“”/>
  <display_text from=“0.701” to=“0.85” type=“WARNING” value=“%name%'s adjusted
  net income is more substantial than its adjusted CFFO less D&A. This is generally a
  sign of poor earnings quality.” direction=“”/>
  <display_text from=“0” to=“0.4” type=“INSIGHT” value=“%name%'s adjusted net
  income is less than its adjusted CFFO less D&A. This is generally a sign of good
  earnings quality.” direction=“”/>
  <display_text from=“0.401” to=“0.70” type=“NONE” value=“%name%'s adjusted net
  income is in line with its adjusted CFFO less D&A. This is generally a sign of good
  earnings quality.” direction=“”/>
  <linguistic_variable name=“balancesheet_quality” type=“OUTPUT”>
      <function name=“Low” values=“0.8,0.9,0.9,1”/>
      <function name=“Average” values=“0.3,0.5,0.5,0.7”/>
      <function name=“High” values=“0,0.2,0.2,0.4”/>
      <function name=“Medium” values=“0.6,0.75,0.75,0.85”/>
  </linguistic_variable>
  <linguistic_variable name=“CF_AdjustedCFFOlessDepreciation_NI” type=“INPUT”>
      <function name=“high” values=“1.2,1.5,2,NULL”/>
      <function name=“low” values=“0.6,0.75,0.75,0.9”/>
      <function name=“Negative” values=“−1.5,−0.5,−0.5,−0.001”/>
      <function name=“Average” values=“0.8,1.2,1.2,1.4”/>
  </linguistic_variable>
  <linguistic_variable name=“CF_AdjustedCFFO_minus_depreciation” type=“INPUT”>
      <function name=“Positive” values=“0,1,2,NULL”/>
      <function name=“Negative” values=“NULL,−2,−1,0”/>
  </linguistic_variable>
  <linguistic_variable name=“CF_Adjusted_NI” type=“INPUT”>
      <function name=“Positive” values=“0,1,2,NULL”/>
      <function name=“Negative” values=“NULL,−2,−1,0”/>
  </linguistic_variable>
  <analysis_periods>
      <period_type value=“A” num_periods=“5”/>
      <period_type value=“Q” num_periods=“5”/>
  </analysis_periods>
  <dependency>
      <callee value=“CF_AdjustedCFFOlessDepreciation_NI”/>
      <callee value=“CF_AdjustedCFFO_minus_depreciation”/>
      <callee value=“CF_Adjusted_NI”/>
  </dependency>
</rule>
</rules>
```

The analytics engine 640 provides for the evaluation of the growth trend function using a method called FISH (First Half Second Half Method). In this method, the period in consideration for calculating a trend is divided into two halves and each of the halves would be evaluated using a fuzzy equation. The latest periods are given a higher priority during the evaluation. The two halves are considered as input linguistic variables and the membership functions used by these input linguistic variables are defined as a growth trend template. The values set for the input linguistic variables are the slope of the line plotted for the respective half. The output linguistic variable is a growth trend which is the evaluation result of the above two input linguistic variables (FHMF and SHMF).

The fuzzy equation used for evaluating a growth trend function is:

if FHMF is declining and SHMF is declining then GrowthTrend is
Negative
if FHMF is declining and SHMF is flat then GrowthTrend is Flat
if FHMF is declining and SHMF is increasing then GrowthTrend is
Positive
if FHMF is flat and SHMF is declining then GrowthTrend is Negative
if FHMF is flat and SHMF is flat then GrowthTrend is Flat
if FHMF is flat and SHMF is increasing then GrowthTrend is Positive
if FHMF is increasing and SHMF is declining then GrowthTrend is
Negative
if FHMF is increasing and SHMF is flat then GrowthTrend is Flat
if FHMF is increasing and SHMF is increasing then GrowthTrend is
Positive

The value returned by the above equation for the output linguistic variable (growth trend) is the value that is set for the input linguistic variable used in the fuzzy equation. The format of the growth trend function used in the main fuzzy equation is:
Growth Trend(<simple-or-complex-data-item>,<number-of-periods>,<template-name>

The analytics engine 640 provides for the evaluation of the volatility function using fuzzy evaluation. The volatility is calculated for the values in consideration using one of the following three methods
Standard Deviation on Normalized Values
Standard Deviation on Logarithmic values
Linear Trend Regression

This volatility value is used to set the output linguistic variable ‘Volatility’ that defines the membership function ‘volatile’. This output linguistic variable will be the input linguistic variable in the main fuzzy rule.

The analysis server 660 is an online system which triggers the evaluation of analysis based on the following criteria.
1. Change in the analysis
2. New/Updated data in the input data store
3. Updated market data. This is updated on a daily basis. This would result in the evaluation of analysis that uses market data.
4. Online analysis due to change in peers
5. Online analysis due to user interactivity.

The analysis server 660 generates the results for the analysis marked as benchmarks and subsequently evaluates the rest of the analysis. This functionality is the subsystem “Benchmark Server/Generator”. The analysis server 660 also acts as a back-testing server that provides the result values to enable us to verify the sanctity of the data as well as the analysis. The analysis server 660 provides for the facility to generate historical analysis results which can be used to look at the past performance of the company.

Analysis store 670 saves the results of each individual analytical evaluation. The analysis store 670 is queried to generate a higher level of analysis based on the hierarchy discussed above. Each result of the analysis contains detailed supporting data which is helpful in options provided to users by the presentation framework.

A presentation framework facilitates the user to browse the analysis database 670 interactively. It allows the user to interact with the product, specify requirements for custom models, look deeply into “what if” scenarios, thereby helping him or her in making investment decisions. A dashboard provides a snapshot of the overall performance of the company, industry/sector and depicts the results of the model level evaluation of the company along with its historical analysis results.

The presentation framework provides for a click thru to present an overview of analysis of each component in the dashboard. Analysis details are shown in a human language with supporting data (with drill downs to the source of data that usually is a semi-structured document such as an SEC filing). The presentation framework supports interactive analysis like the facility to change the assumptions made in reported financials and look at the analysis based on the user's assumptions.

The presentation framework supports displaying comparative data for each analysis across peers, industry and sector. It also supports different representations of analysis for different user sets—equity analyst, credit analyst, corporate finance personnel, law firms, etc. The presentation framework provides customization based on user preferences (like dashboard layout, portfolios management, and an ability to customize the layout of the analysis details view) with the help of a user control panel. It also supports the capture of requirements for custom or user specific models along with presentation of the results of the model.

The framework provides for the download of the report to local computers in various formats like PDF, XLS, Word document etc, customized print-out, delivery of alerts to wireless devices. The framework supports the generation of custom feeds to other systems such as external valuation models. A company notebook is provided where the user can add his thoughts and/or gather external information about the analysis for a company. The contents of the notebook can be added to the exported report. Users of system 200 may share thoughts on the analysis through a user forum. A screener facility is provided to enable the user to search for companies with specific criteria. The criteria could range from any data point in the input data store (semis structured data, financial data, news items etc) or analysis store (analysis level, model level, company level etc. result data).

A method and system for advanced financial analysis have been disclosed. Although the present methods and systems have been described with respect to specific examples and subsystems, it will be apparent to those of ordinary skill in the art that it is not limited to these specific examples or subsystems but extends to other embodiments as well.

We claim:

1. A computer-implemented method, comprising:
collecting financial data from a plurality of data sources;
extracting information from the financial data using a company specific template;
analyzing the information to generate results using customizable rules stored in a rules database; and
providing the results to a user through a display device.

2. The computer-implemented method of claim 1, wherein the plurality of data sources include a database including SEC reports, news data, market-wide data, and private research reports.

3. The computer-implemented method of claim 2, wherein analyzing the information further comprises analyzing off balance sheet items; and analyzing academic models.

4. The computer-implemented method of claim 3, further comprising adjusting the academic models automatically based on the information.

5. The computer-implemented method of claim 4, further comprising executing one or more fuzzy logic rules.

6. The computer-implemented method of claim 5, further comprising generating a score for each academic model of the academic models.

7. The computer-implemented method of claim 6, further comprising providing one or more evaluations, the evaluations including an information level evaluation, a model level evaluation, a company level evaluation, a peer level evaluation, a portfolio level evaluation, an industry level evaluation, a sector level evaluation, and a macro economic level evaluation.

8. A computer program product tangibly embodied in a computer readable medium, the computer program product comprising instructions operable to cause a data processing equipment to:
collect financial data from a plurality of data sources;
extract information from the financial data using a company specific template;
analyze the information to generate results using customizable rules stored in a rules database; and
provide the results to a user through a display device.

9. The computer program product of claim 8, wherein the plurality of data sources include a database including SEC reports, news data, market-wide data, and private research reports.

10. The computer program product of claim 9, wherein analyzing the information further comprises analyzing off balance sheet items; and analyzing academic models.

11. The computer program product of claim 10, further comprising instructions operable to cause the data processing equipment to adjust the academic models automatically based on the information.

12. The computer program product of claim 11, further comprising instructions operable to cause the data processing equipment to execute one or more fuzzy logic rules.

13. The computer program product of claim 12, further comprising instructions operable to cause the data processing equipment to generate a score for each academic model of the academic models.

14. The computer program product of claim 13, further comprising instructions operable to cause the data processing equipment to provide one or more evaluations, the evaluations including an information level evaluation, a model level evaluation, a company level evaluation, a peer level evaluation, a portfolio level evaluation, an industry level evaluation, a sector level evaluation, and a macro economic level evaluation.
